(19) United States
(12) Patent Application Publication
(10) Pub. No.: US 2002/0165800 A1
(43) Pub. Date: Nov. 7, 2002

(54) Processing system

(76) Inventors: Kazuhiro Ogura, Kawasaki-shi (JP); Takeshi Oogaki, Tokyo (JP); Yasushi Oowa, Tokyo (JP); Yoshiko Takeda, Yokohama-shi (JP)

Correspondence Address: Johnny A. Kumar, FOLEY & LARDNER, Washington Habour, 3000 K Street, N.W., Suite 500, Washington, DC, 20007-5109, US

(21) Appl. No.: 09/845,259

(22) Filed: May 1, 2001

(51) Int. Cl. G06F 17/60

(52) U.S. Cl. 705/27

(57) ABSTRACT

When a print button of a customer display device has been depressed, a control unit of a cash register transmits to a digital copying machine print data of details of a displayed advertisement and an application form for a commodity, thereby printing the details of the advertisement or the application form for the commodity. When a customer faxes the application form with necessary items filled in, the customer faxes the content of the application form to a destination facsimile number stated on the application form by using a FAX apparatus. The data of the application form faxed by the FAX apparatus is received by a FAX server of a data center over a public line, converted to image data, and transferred to an application form processing unit.

### BACKGROUND OF THE INVENTION

The present invention relates to a processing system for performing a sale processing by advertising a commodity using, for example, a POS (Point of Sales) system.

In a conventional POS (Point of Sales) system, a POS terminal is disposed on a sales floor in a department store, a supermarket, a specialty store, a retail store, or the like. The POS terminal instantaneously collects data for use in individual commodity management, customer management, sales management, etc. In general, the POS terminal has a register function, a file function for temporarily storing data, and an on-line function for connection to an upper level apparatus. In an example of the POS terminal, an automatic reader such as a stationary scanner or a handheld scanner is used as means for inputting commodity codes (maker codes, item codes), in addition to key-input means. A printed commodity code comprising OCR characters or a bar code is automatically read. Information on the flow of a commodity is produced at the time point of sale and transmitted on-line to an upper level apparatus.

Jpn. Pat. Appln. KOKAI Publication No. 6-333159, Jpn. Pat. Appln. KOKAI Publication No. 10-307970 and Jpn. Pat. Appln. KOKAI Publication No. 7-272119 disclose techniques wherein a commercial video moving picture, etc. is displayed on a screen of a display device for customers provided on a rear face of a cash register of the POS system. Thus, advertisements with impacts can be provided to a customer, for whom an accounting is being performed or who is waiting for an accounting.

Jpn. Pat. Appln. KOKAI Publication No. 2000-20552 discloses a catalog inspection/order system using a personal computer and the Internet. If one wishes to make an application or place an order, using a postcard image displayed on a catalog information screen, he/she clicks a postcard print-out button. Thus, he/she obtains a printed-out postcard for immediate mailing.

However, in the advertisement using a customer display (LCD) of a cash register in the POS system, it is not possible to provide a customer, who is interested in an advertisement, with printed-out detailed information, or to provide an ordering means. In addition, if a postcard is used as ordering means, the shop has to bear a communication cost, or the user has to additionally purchase a postage stamp.

When an order is placed using an application form, it is important to acquire detailed information, such as the name of a shop that received the application form and the time of reception of the application form, whereby the effect of advertisement can be monitored to prepare more effective next advertisements. In the prior art, a shop stamp, for example, has been put on application forms, but this method provides too little information.

### BRIEF SUMMARY OF THE INVENTION

An object of the present invention is to provide a processing system wherein when a customer, who has an interest in an advertisement displayed on a customer display device disposed on a POS terminal of a POS system, has depressed a print button, not only an application form but also detailed commodity information is provided, whereby an effective description of a commodity can be provided and, accordingly, a sales increase can be achieved, without increasing an occupation time of the POS system or decreasing the efficiency of the POS terminal.

Another object of the invention is to provide a processing system capable of displaying an advertisement of a related commodity, as detailed information, on a customer display device disposed on a POS terminal of a POS system.

Still another object of the invention is to provide a processing system capable of providing an application form, which is not a postcard but a facsimile-adaptable form, in association with an advertisement displayed on a customer display device disposed on a POS terminal of a POS system, whereby an application can be made through a household facsimile device.

Still another object of the invention is to provide a processing system capable of providing an application form containing an ID and various data in association with an advertisement displayed on a customer display device disposed on a POS terminal of a POS system, whereby information such as an advertisement time and a condition can be totaled and useful data acquired.

In order to achieve the objects, the invention provides a processing system comprising a terminal device for performing sales management of a commodity purchased by a customer, on the basis of a commodity code put on the commodity, a copying machine connected to the terminal device over a line, and a center, connected to the terminal device over a line, for managing the terminal device, wherein the center comprises: first transmission means for transmitting advertisement information to the terminal device; and a database for storing print data of detailed information of the advertisement or an application form, the terminal device comprises: display means for displaying the advertisement to the customer on the basis of the advertisement information transmitted from the center; instruction means, provided near the display means, for instructing printing of the detailed information of the advertisement or the application form, which is displayed on the display means; and processing means for reading out the print data of the displayed detailed information of the advertisement or the application form from the database of the center in accordance with an instruction from the instruction means, and transmitting the read-out data to the copying machine, and the copying machine comprises: printing means for performing printing based on the print data of the detailed information of the advertisement or the application form, which is transmitted from the terminal device.

The invention also provides a processing system comprising a terminal device for performing sales management of a commodity purchased by a customer, on the basis of a commodity code put on the commodity, a copying machine connected to the terminal device over a line, and a center, connected to the terminal device over a line, for managing the terminal device, wherein the center comprises: first transmission means for transmitting advertisement information to the terminal device; and a database for storing print data of detailed information of the advertisement or an application form, the terminal device comprises: display means for displaying the advertisement to the customer on the basis of the advertisement information transmitted from the center; instruction means, provided near the display means, for instructing printing of the detailed information of the advertisement or the application form, which is displayed on the display means; and processing means for reading out print data of the displayed detailed information of the advertisement or the application form from the database of the center in accordance with an instruction from the instruction means, and transmitting the read-out data to the copying machine, and the copying machine comprises: printing means for performing printing based on the print data of the detailed information of the advertisement or the application form, which is transmitted from the terminal device; reading means for reading the application form which has been printed by the printing means and on which necessary items have been filled in; and second transmission means for transmitting image data of the application form read by the reading means to the center.

The invention provides a processing system comprising a terminal device for performing sales management of a commodity purchased by a customer, on the basis of a commodity code put on the commodity, a copying machine connected to the terminal device over a line, and a center, connected to the terminal device over a line, for managing the terminal device, the center having a facsimile server for receiving transmission information from a facsimile apparatus, wherein the center comprises: first transmission means for transmitting advertisement information to the terminal device; and a database for storing print data of detailed information of the advertisement or an application form, the terminal device comprises: display means for displaying the advertisement to the customer on the basis of the advertisement information transmitted from the center; instruction means, provided near the display means, for instructing printing of the detailed information of the advertisement or the application form, which is displayed on the display means; and control means for reading out the print data of the displayed detailed information of the advertisement or the application form from the database of the center in accordance with an instruction from the instruction means, and executing a print-out control through the copying machine on the basis of the print data of the detailed information or the application form, and the facsimile apparatus comprises: reading means for reading the application form which has been printed from the copying machine by the control of the control means and on which necessary items have been filled in; and transmission means for transmitting image data of the application form read by the reading means to the center.

The invention provides a processing system comprising a terminal device for performing sales management of a commodity purchased by a customer, on the basis of a commodity code put on the commodity, a copying machine connected to the terminal device over a line, and a center, connected to the terminal device over a line, for managing the terminal device and transmitting advertisement information to the terminal device, the center having a database for storing print data of detailed information of an advertisement or an application form, wherein the terminal device comprises: display means for displaying the advertisement to the customer on the basis of the advertisement information transmitted from the center; instruction means, provided near the display means, for instructing printing of the detailed information of the advertisement or the application form, which is displayed on the display means; and processing means for reading out the print data of the displayed detailed information of the advertisement or the application form from the database of the center in accordance with an instruction from the instruction means, and transmitting the read-out data to the copying machine, the copying machine comprises: printing means for performing printing based on the print data of the detailed information of the advertisement or the application form, which is transmitted from the terminal device; reading means for reading the application form which has been printed by the printing means and on which necessary items have been filled in; and transmission means for transmitting image data of the application form read by the reading means to the center, and the center comprises: control means for transmitting, to the copying machine application, result information on an application by the application form, which is based on the image data of the application form transmitted by the transmission means, and executing a control to print out the result information of the application through the copying machine.

The invention provides a processing system comprising a terminal device for performing sales management of a commodity purchased by a customer, on the basis of a commodity code put on the commodity, a copying machine connected to the terminal device over a line, and a center, connected to the terminal device over a line, for managing the terminal device and transmitting advertisement information to the terminal device, the center having a database for storing print data of detailed information of an advertisement or an application form, wherein the terminal device comprises: display means for displaying the advertisement to the customer on the basis of the advertisement information transmitted from the center; instruction means, provided near the display means, for instructing printing of the detailed information of the advertisement or the application form, which is displayed on the display means; and processing means for reading out the print data of the displayed detailed information of the advertisement or the application form from the database of the center in accordance with an instruction from the instruction means, and transmitting the read-out data to the copying machine, the copying machine comprises: printing means for performing printing based on the print data of the detailed information of the advertisement or the application form, which is transmitted from the terminal device; reading means for reading the application form which has been printed by the printing means and on which necessary items have been filled in; and transmission means for transmitting image data of the application form read by the reading means to the center, and the center comprises: information transmission means for transmitting, to a predetermined information transmission destination, result information on an application by the application form, which is based on the image data of the application form transmitted by the transmission means.

The invention provides a processing system comprising a terminal device for performing sales management of a commodity purchased by a customer, on the basis of a commodity code put on the commodity, a copying machine connected to the terminal device over a line, and a center, connected to the terminal device over a line, for managing the terminal device and transmitting advertisement information to the terminal device, the center having a database for storing print data of detailed information of an advertisement or an application form, wherein the terminal device comprises: settlement means for performing an accounting for the commodity purchased by the customer; display means for displaying the advertisement to the customer on the basis of the advertisement information transmitted from the center; instruction means, provided near the display means, for instructing printing of the detailed information of the advertisement or the application form, which is displayed on the display means; processing means for reading out the print data of the displayed detailed information of the advertisement or the application form from the database of the center in accordance with an instruction from the instruction means, and transmitting the read-out data to the copying machine; and transmission means for transmitting, when personal information has been acquired in the accounting by the settlement means, the personal information to the digital copying machine, and the copying machine comprises: reception means for receiving the print data of the detailed information and the application form, which has been transmitted from the processing means, and the personal information transmitted by the transmission means; and control means for printing out the print data of the detailed information and the application form, which has been received by the reception means, by adding thereto the personal information.

The invention provides a processing system comprising a terminal device for performing sales management of a commodity purchased by a customer, on the basis of a commodity code put on the commodity, a copying machine connected to the terminal device over a line, and a center, connected to the terminal device over a line, for managing the terminal device and transmitting advertisement information to the terminal device, the center having a database for storing print data of detailed information of an advertisement or an application form, wherein the terminal device comprises: display means for displaying the advertisement to the customer on the basis of the advertisement information transmitted from the center; instruction means, provided near the display means, for instructing printing of the detailed information of the advertisement or the application form, which is displayed on the display means; and processing means for reading out the print data of the displayed detailed information of the advertisement or the application form from the database of the center in accordance with an instruction from the instruction means, and transmitting the read-out data to the copying machine, the copying machine comprises: printing means for performing printing based on the print data of the detailed information of the advertisement or the application form, which is transmitted from the terminal device; reading means for reading the application form which has been printed by the printing means and on which necessary items have been filled in; and transmission means for transmitting image data of the application form read by the reading means to the center, and the center comprises: recognition means for recognizing the filled-in information on the application form on the basis of the image data of the application form transmitted by the transmission means; and transfer means for transferring the information recognized by the recognition means along with the image data to an advertiser of the advertisement.

The invention provides a processing system comprising a terminal device for performing sales management of a commodity purchased by a customer, on the basis of a commodity code put on the commodity, a copying machine connected to the terminal device over a line, and a center, connected to the terminal device over a line, for managing the terminal device, the center having a database for storing information including advertisement information, print data of detailed information of an advertisement or an application form, and accounting information of the commodity purchased by the customer, wherein the terminal device comprises: settlement means for performing an accounting for the commodity purchased by the customer; display means for displaying the advertisement to the customer on the basis of the advertisement information transmitted from the center; instruction means, provided near the display means, for instructing printing of the detailed information of the advertisement or the application form, which is displayed on the display means; and control means for executing, when the printing has been instructed by the instruction means, a control to read out from the center the print data of the detailed information of the commodity of the displayed advertisement and the application form, and the center comprises: correlation analysis means for performing a correlation analysis on the basis of a database for storing the print data of the detailed information and the application form, which is read out by the control of the control means, a database for storing the advertisement information transmitted to the terminal device, and a database for storing accounting information acquired in the accounting by the settlement means; and updating means for updating the database storing the advertisement information on the basis of a result of the correlation analysis means.

### BRIEF DESCRIPTION OF SEVERAL VIEWS OF THE DRAWING

FIG. 1 is a block diagram showing a system structure of a processing system according to a first embodiment;

FIG. 2 shows a control panel of a digital copying machine;

FIG. 3 shows the structure of an advertisement DB;

FIG. 4 shows an example of the structure of an application receiver table in the advertisement DB;

FIG. 5 shows an application form print data file structure in the advertisement DB;

FIG. 6 shows a layout.ini structure;

FIG. 7 shows an example of a printed application form produced using the present system;

FIG. 8 shows an example of an application form ID DB;

FIG. 9 shows an example of the application form ID DB;

FIG. 10 shows a structure of a basket DB that manages a basket;

FIG. 11 shows a structure of the basket DB that manages a basket;

FIG. 12 is a flow chart illustrating an operation in a POS-adaptable cash register to which the present invention is applied;

FIG. 13 is a flow chart illustrating a customer-associated operation at a time a print button has been depressed;

FIG. 14 shows an example of display at a time the mode has been switched to an application mode;

FIG. 15 is a flow chart illustrating an application form printing operation;

FIG. 16 is a flow chart illustrating an operation for transferring an image of an application form from the digital copying machine to a data center;

FIG. 17 is a flow chart illustrating an image file transmission operation in the digital copying machine;

FIG. 18 is a block diagram showing a system structure of a processing system according to a second embodiment;

FIG. 19 shows the structure of an item-by-item inventory table relating to items to be applied for by an application form;

FIGS. 20A and 20B show structures of substitute commodity tables;

FIG. 21 shows an example of the structure of an application reception notice;

FIG. 22 shows an example of the structure of an out-of-stock notice;

FIG. 23 is a flow chart illustrating a processing operation of an application form processing apparatus;

FIG. 24 is a flow chart illustrating an operation in which the application form processing apparatus notifies a user by an E-mail and an application for a substitute commodity is made over the Web;

FIG. 25 shows an example of a mail, which is the application reception notice;

FIG. 26 shows an example of a mail, which is the out-of-stock notice;

FIG. 27 shows an example of a mail, which is the out-of-stock notice;

FIG. 28 is a flow chart illustrating an application form printing operation;

FIG. 29 is a flow chart illustrating an operation in which a user profile is acquired and the user profile is sent to the digital copying machine;

FIG. 30 is a flow chart illustrating an application form processing operation in the application form processing apparatus; and

FIG. 31 shows an example of the structure of a user information management DB.

### DETAILED DESCRIPTION OF THE INVENTION

A first embodiment of the present invention will now be described with reference to the accompanying drawings.

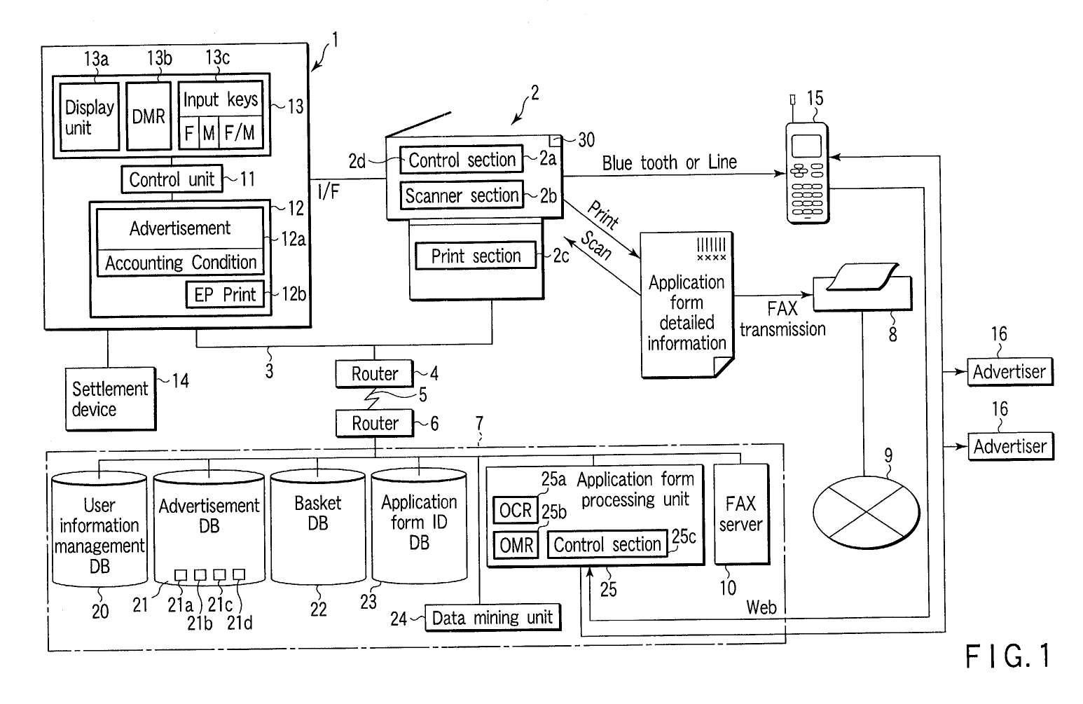

FIG. 1 shows a system structure of a processing system according to the first embodiment. In a shop, a terminal 1, which is adaptable to POS (Point of Sales), and a digital copying machine 2 are connected via an interface (I/F) such as IEEE1394. In the following description, the POS-adaptable terminal 1 is described as a POS-adaptable cash register 1 that is commonly used as a POS-adaptable terminal.

The POS-adaptable cash register 1 and digital copying machine 2 are connected to an intra-shop network 3. The intra-shop network 3 is connected to a data center 7 via a first router 4 provided within the shop, a shop network 5 and a second router 6.

The POS-adaptable cash register 1 comprises a control unit 11 for performing a whole control; a display device 12 for customers, including a display 12a capable of displaying an accounting condition and an advertisement to a customer, and a print button 12b with which a user having an interest in the advertisement instructs printing; an input device 13 for store clerks, including a display unit 13a for displaying an account price when a store clerk performs an accounting, an OMR (optical mark reader) 13b for reading a bar code as an item code of a commodity purchased by the customer, and input keys 13c for input; and a settlement device 14 for inputting a card reader password, etc.

The digital copying machine 2 comprises a control section 2a, a scanner section 2b and a print section 2c. The control section 2a is provided with a buffer 2d for temporarily storing an image, as will be described later. The digital copying machine 2 is able to communicate with, for example, a mobile terminal such as a mobile phone 15 possessed by a user over Bluetooth, a line, etc. The digital copying machine 2 has a control panel 30.

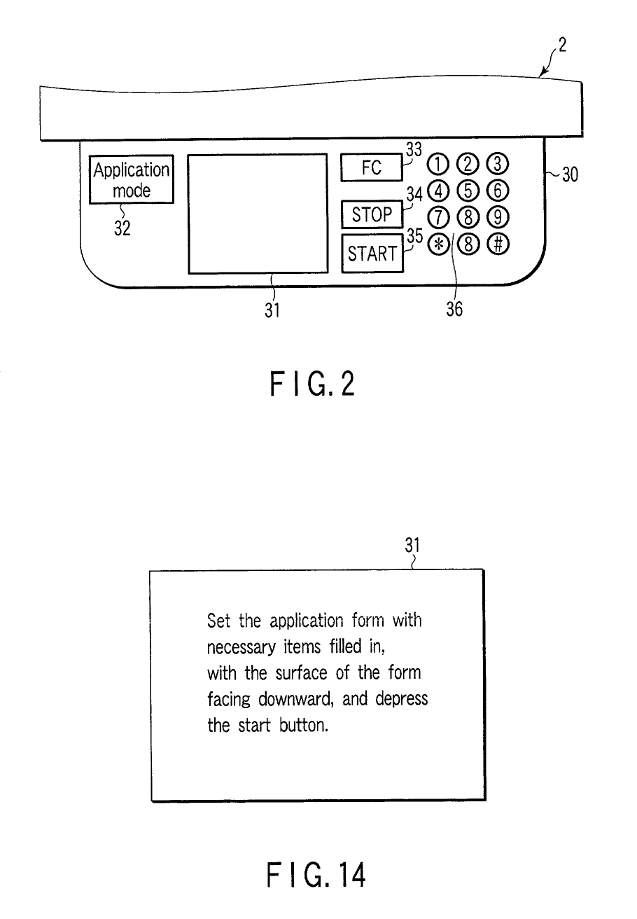

FIG. 2 shows the control panel 30. The control panel 30 comprises a display section 31 composed of a liquid crystal display with a touch panel; an application mode switch button 32 provided for use in the present embodiment; a function key 33; a stop key 34; a start key 35; and numeral keys 36.

A facsimile (FAX) apparatus 8, through which a user makes an application using a commodity application form obtained according to the present invention, is disposed in the shop. The FAX apparatus 8 can be connected to a FAX server 10 of the data center 7 over a public line 9, etc.

The data center 7 comprises a user information management database (DB) 20, an advertisement database (DB) 21, a basket database (DB) 22, an application form ID database (DB) 23, a data mining unit 24, an application form processing unit 25, and the FAX server 10.

The user information management DB 20 stores data that has been transferred from a user information management database managed by, e.g. a telephone company or a credit company.

The advertisement DB 21 stores advertisement information to be displayed on the customer display device 12 of the POS-adaptable cash register 1. The advertisement DB 21 comprises an advertisement data table 21a, an application receiver table 21b, an application form print data file structure 21c and a layout.ini structure 21d.

The basket DB 22 is a database for managing data corresponding to a receipt of a single account for a customer at the cash register 1.

The application form ID DB 23 is a database for associating an ID printed on an application form with other information.

The data mining unit 24 extracts useful data from the basket DB 22 and application form ID DB 23 by applying a data mining technique such as correlation analysis, and reflects the extracted result on the advertisement DB 21.

The application form processing unit 25 has an OCR (optical character reader) function 25a for taking out necessary data (an application receiver, etc.) from the application form received in the form of image data; and an OMR (optical mark reader) function 25b for taking out an application ID from the bar code on the application form received in the form of image data. The application form processing unit 25 includes a control section 25c for controlling these functions. In addition, the application form processing unit 25 transfers image data of the application form and a corresponding OCR result to corresponding advertisers 16 by E-mail, as will be described later in detail.

When a user makes an application using the facsimile (FAX), the FAX server 10 receives data from the public line 9 and converts it to image data, and then sends the converted image data to the application form processing unit 25.

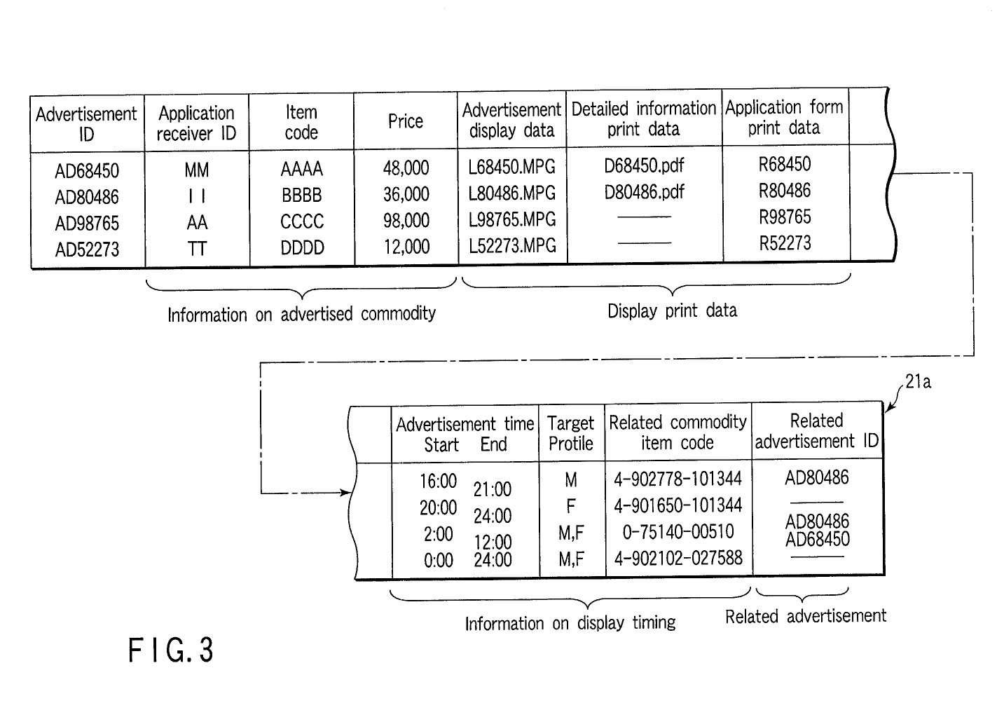

FIG. 3 shows the structure of the advertisement data table 21a.

The advertisement data table 21a stores an advertisement ID for identifying an advertisement; commodity information on an advertised commodity; display print data comprising display data to be displayed on the customer display device 12 and print data to be printed; timing information on the timing of advertisement display; and related information on an advertisement related to the present advertisement. The advertisement data table 21a stores the information as one record for one advertisement.

The commodity information in this example comprises an application receiver ID for identifying the advertiser 16; an item code put on a commodity by the advertiser in order to discriminate the commodity; and a commodity price.

The display print data comprises advertisement display data as video data to be displayed on the customer display device 12; detailed information print data (PS or PDF being available) for producing a printed matter providing more detailed information on the commodity; and application form print data for producing an application form. The detailed information print data is dispensed with, if a sufficient description of a commodity appears on the application form.

The timing information in this example comprises a start time and an end time of an advertisement time period as a time slot for advertisement display; a target profile for determining whether the advertisement is to be displayed, in accordance with the profile of a customer; and a related commodity item code for determining whether the advertisement is to be displayed, in accordance with a commodity purchased by the customer and a time of purchase (when an account for the commodity is settled by the POS-adaptable cash register). The target profile is, for example, the sex of the customer.

The related information in this example is an advertisement ID of a commodity, information on which is to be provided (printed) at the same time as (printing of) detailed information or an application form on an advertisement is requested.

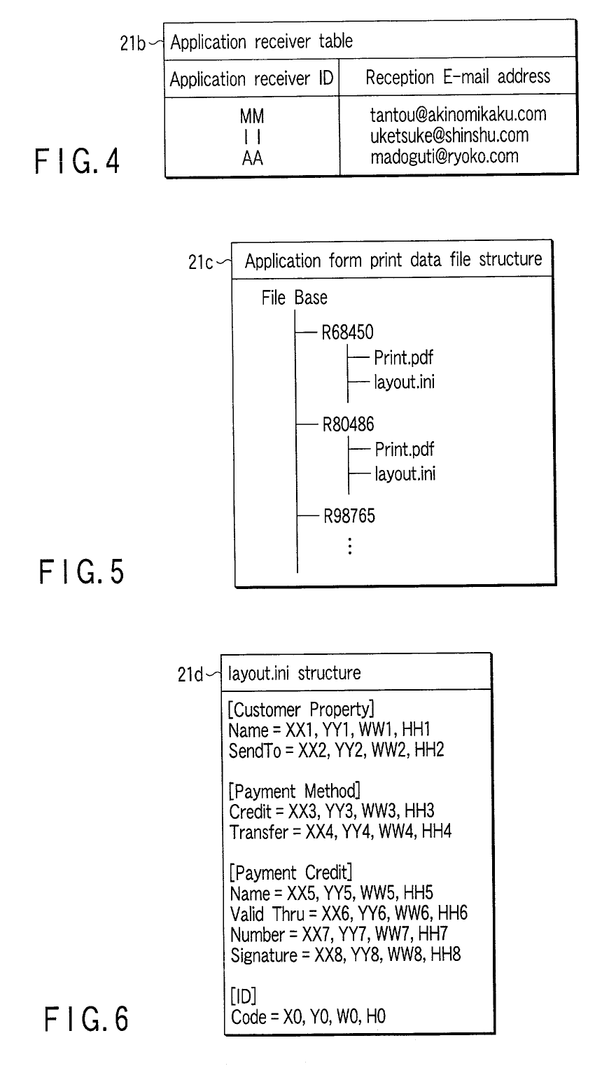

FIG. 4 shows an example of the structure of the application receiver table 21b. The application receiver table 21b stores a reception E-mail address in association with the application receiver ID shown in FIG. 3.

FIG. 5 shows the application form print data file structure 21c. The application form print data file structure 21c comprises File Base, ID numbers of application form print data, Print.pdf, and layout.ini.

FIG. 6 shows the layout.ini structure 21d. The layout.ini structure 21d comprises Customer Property, Payment Method, Payment Credit, and ID.

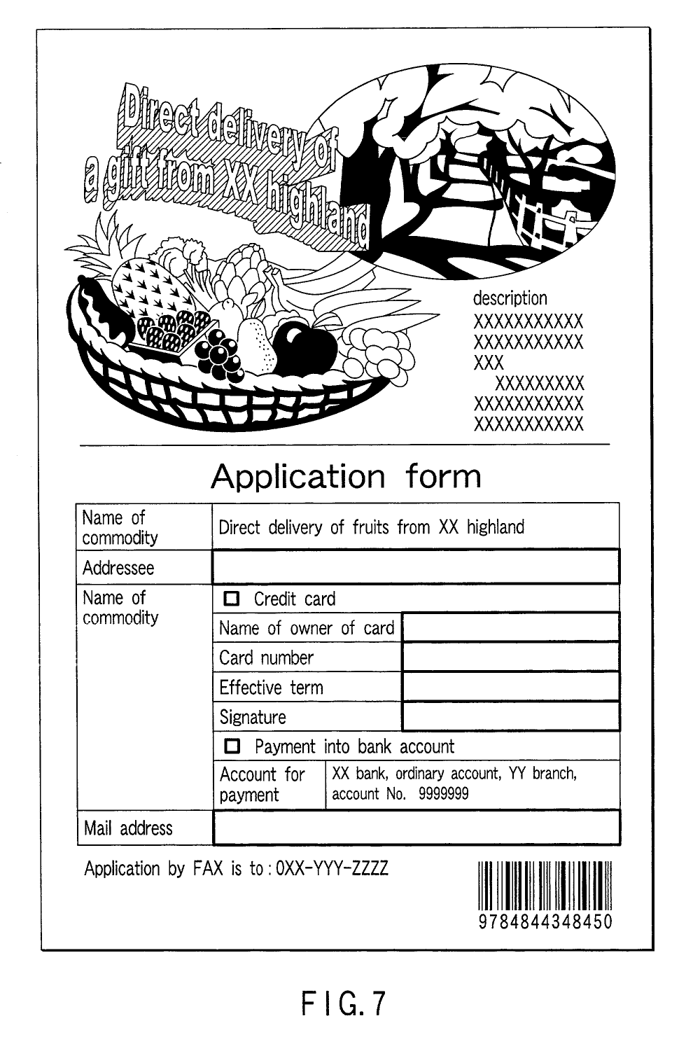

FIG. 7 shows an example of a printed application form produced using the present system.

In this example, a commodity image and a description of the commodity are printed on an upper part. Fill-in items for application are printed on a middle part. An application form ID for identifying the application form is printed on a lower part in the form of a bar code.

The application form ID may be put on the application form, not only by means of the bar code, but also by means of a two-dimensional bar code, an OCR font print, or an invisible record (e.g. print data of an ink invisible to the human eye).

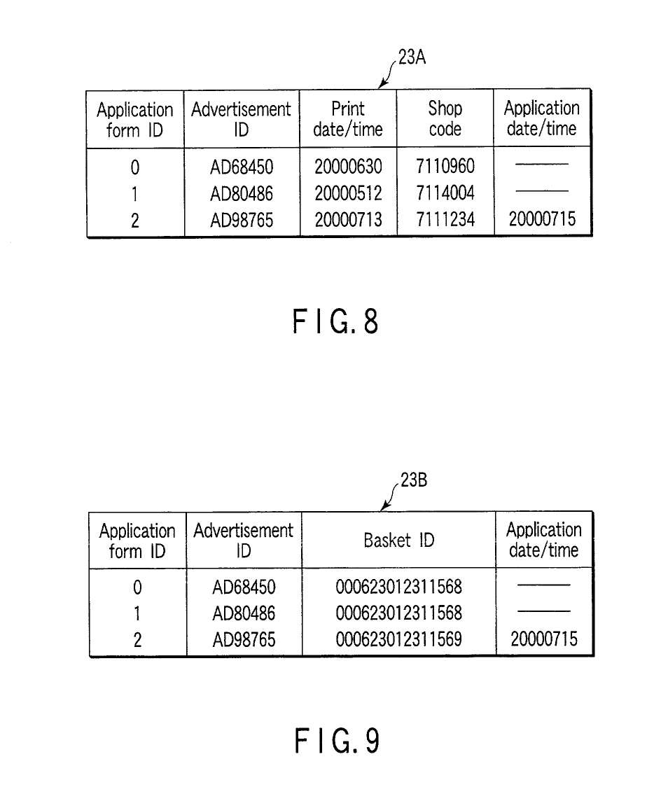

FIGS. 8 and 9 show structures of the application form ID DB 23.

The structure of the application form ID DB 23 differs between a case where POS account data (basket data) for a customer is provided and a case where it is not provided.

Where the POS account data is not provided, an application form ID table 23A, as shown in FIG. 8, is used. An application form ID is issued for each application form and is managed as one record of the application form ID table 23A. The application form ID table 23A in this example comprises an application form ID as an ID of an application form; an advertisement ID indicative of an advertisement, an application form of which is to be printed out by a print-out instruction (i.e. an advertisement being displayed when the print button 12b has been depressed); a print date/time of the printed-out application form; a shop code indicative of the shop where the application form was printed; and an application date/time.

Where the POS account data is provided, an application form ID table 23B, as shown in FIG. 9, is used. An application form ID is issued for each application form and is managed as one record of the application form ID table 23B. The application form ID table 23B comprises an application form ID as an ID of an application form; an advertisement ID indicative of an advertisement, an application form of which is to be printed out by a print-out instruction (i.e. an advertisement being displayed when the print button 12b has been depressed); a basket ID indicative of an account operation, for acquiring other data from a basket representing the account operation associated with the advertisement; and an application date/time.

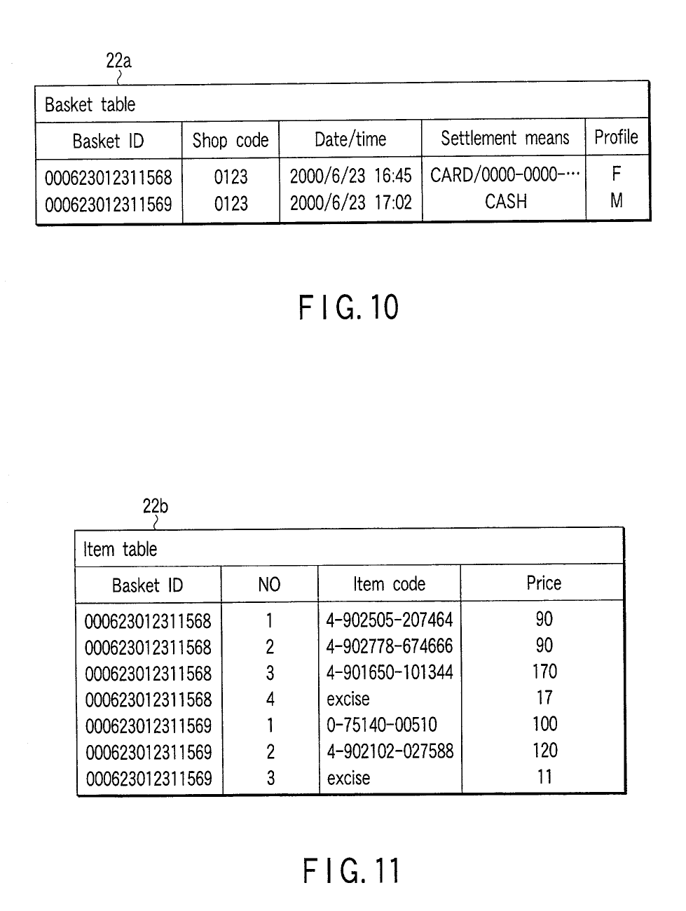

FIGS. 10 and 11 show structures of the basket DB 22 for managing the basket. The basket DB 22 is required only in the case of the application form ID table 23B shown in FIG. 9, as mentioned above.

The basket DB 22 comprises a basket table 22a for managing the basket itself, as shown in FIG. 10, and an item table 22b for managing items contained in the basket, as shown in FIG. 11.

The basket table 22a manages information on a single accounting operation for the customer in the POS system. One record is stored for one receipt. The basket table 22a stores a basket ID representative of a basket; a shop code representative of a shop where the accounting operation was performed; the date/time of the accounting; settlement means; and Profile indicative of the customer's profile. In this example, the sex of the customer is stored as the customer's profile because of the ease in inputting.

The item table 22b manages items contained in the basket. One record is stored for one item described on the receipt. The item table 22b stores a basket ID representative of a basket in which the item is contained; a serial number in the basket; an item code; and a price.

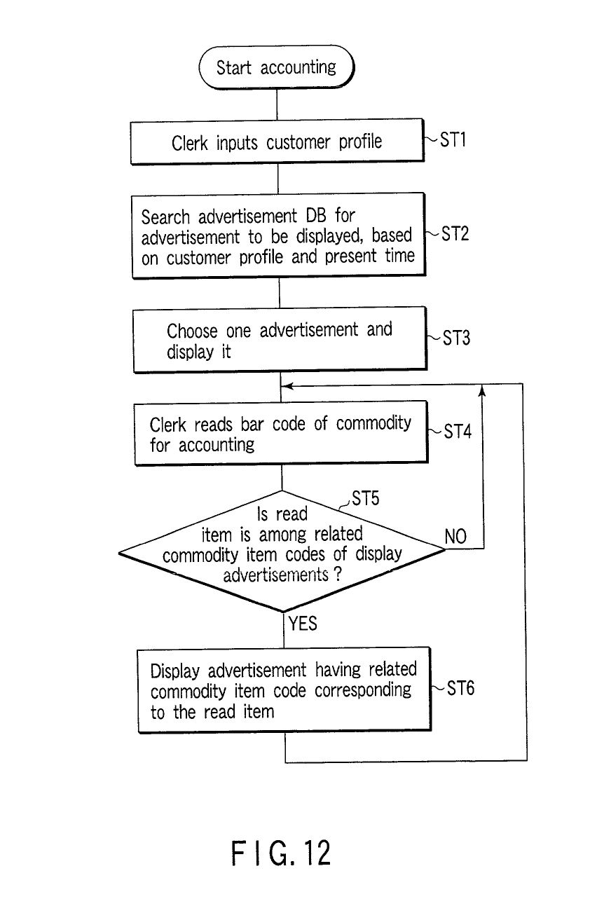

Referring to a flow chart of FIG. 12, a description will now be given of the operation of the POS-adaptable cash register 1 with the above structure, to which the present invention has been applied.

At the beginning of an accounting operation, a store clerk inputs the customer's profile through the input device 13 for store clerks of the cash register 1 (ST1).

The control unit 11 of cash register 1 connects to the data center 7 via the intra-shop network 3, intra-shop first router 4, shop network 5 and second router 6. Based on the input customer profile and the present time, the control unit 11 searches the advertisement data table 21a for the advertisement ID and related commodity item code, which correspond to the target profile and meet the start and end times of the advertisement time period (ST2).

The control unit 11 chooses one of plural retrieved advertisements and transfers the data thereof to the customer display device 12 so that it is displayed (ST3). In steps ST2 and ST3, a cache may be provided in the POS system or intra-shop network in order to increase the operation speed and to decrease the network load.

The bar code (item code) put on the commodity, for which the accounting operation is to be performed by the store clerk, is read by the OMR 13b of the store-clerk input device 13 (ST4).

The control unit 11 connects to the data center 7 via the intra-shop network 3, intra-shop first router 4, shop network 5 and second router 6. The control unit 11 determines whether the item code read by the OMR 13b of the store-clerk input device 13 coincides with the related commodity item code of the advertisement retrieved in step ST2 (ST5). Based on the advertisement ID corresponding to the coinciding related commodity item code, the associated advertisement display data is read out of the advertisement data table 21a and displayed on the customer display device 12 (ST6).

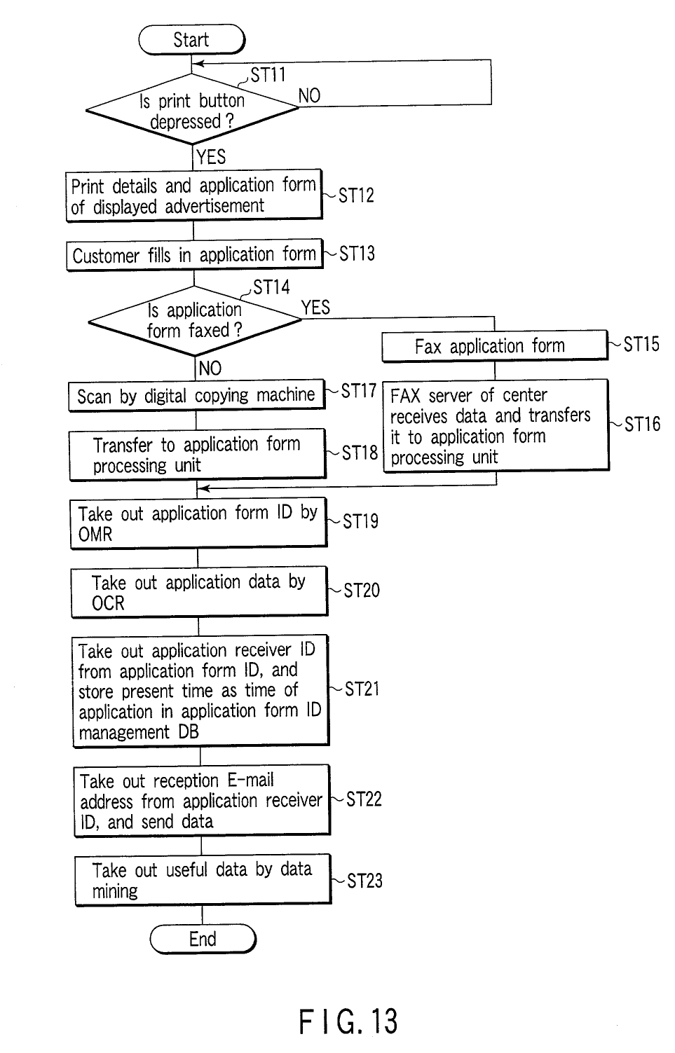

Referring to a flow chart of FIG. 13, a description will now be given of a customer-associated operation at a time the print button 12b of the customer display device 12, which is displaying an advertisement, has been depressed.

If a customer has an interest in the displayed advertisement while an accounting operation is being performed, he/she can depress the print button 12b of the customer display device 12. When the print button 12b of the customer display device 12 has been depressed in the above-described steps ST3 to ST6 (ST11), the control unit 11 of the cash register 1 sends the details of the displayed advertisement and the print information of the commodity application form to the digital copying machine 2, thereby printing out the details of the advertisement and the commodity application form (ST12).

The customer reads the printed-out detailed information (sheet) of the advertisement, which has been produced from the digital copying machine 2, and considers the purchase of the commodity. If the customer wishes to purchase the commodity, he/she fills in necessary items on the printed-out application form (ST13).

If the customer wishes to fax the application form (ST14), he/she faxes the application form at a facsimile number appearing on the application form using the FAX apparatus 8 (ST15). The data of the application form, which has been faxed by the FAX apparatus 8, is received by the FAX server 10 of the data center 7 over the public line 9, converted to image data, and transferred to the application form processing unit 25 (ST16).

Alternatively, the customer is able to make an application using the digital copying machine 2 in the shop handling the services (ST14, 17, 18).

In the case of step ST17, the customer depresses the application mode switch button 32 of the control panel 30 of the digital copying machine 2, thus switching the operation mode to the application mode.

FIG. 14 shows an example of “guidance message” displayed on the display section 31 when the mode has been switched to the application mode. In this example, the guidance message is “Set the application form with necessary items filled in, with the surface of the form facing downward, and depress the start button.”

When the start button 35 has been depressed, the scanner section 2b of the digital copying machine 2 scans the application form and reads the image data, and transfers the image data to the application form processing unit 25 of data center 7 via the intra-shop network 3, intra-shop first router 4, shop network 5 and second router 6 (ST17, 18).

The application form processing unit 25 of data center 7 takes out, using the OMR function 25b, the application form ID from the image data of the application form transferred from the FAX apparatus or digital copying machine 2 (ST19). In addition, the application form processing unit 25 takes out, using the OCR function 25a, the necessary data (e.g. the address of the receiving end) from the image data of the application form (ST20).

The data mining unit 24 accesses the application form ID management DB 23 to take out the advertisement ID on the basis of the application form ID taken out by the application form processing unit 25, and takes out the application receiver ID from the advertisement data table 21a. In this case, the present time is stored in the column “Application date/time” of the associated record on the application ID table (23A or 23B) shown in FIG. 7 or 8 (ST21).

Using the application receiver table 21b based on the application receiver ID, the data mining unit 24 takes out the reception E-mail address and sends the data extracted from the application form by the application form processing unit 25 by E-mail (ST22). Moreover, the data mining unit 24 extracts useful data from the application form ID DB 23 and basket DB 22 by applying a data mining technique such as correlation analysis, and reflects the extracted result on the advertisement data table 21a (ST23).

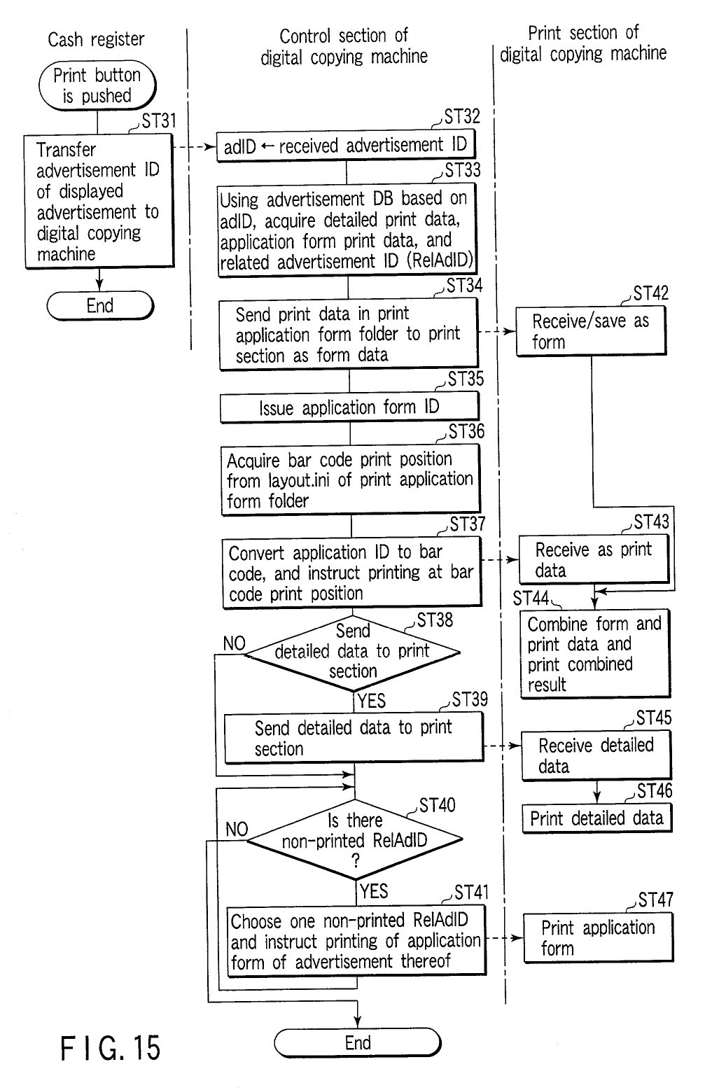

The operation of printing out the application form in step ST12 will now be described with reference to a flow chart of FIG. 15.

When the customer has depressed the print button 12b of the customer display device 12, the control unit 11 of the cash register 1 transfers the advertisement ID of the displayed advertisement to the digital copying machine 2 (ST31).

The control section 2a of the digital copying machine 2 sets the received advertisement ID to be adID (ST32). Using the advertisement DB 21 based on the adID, the control unit 2a acquires detailed print data, application form print data and a related advertisement ID (RelAdID) (ST33). Using the application form print data file structure 21b, the control unit 2a obtains print data (Print.pdf) from the folder (print application form folder) having a name indicated by the application print data in the advertisement DB 21, and transmits it to the print section 2c as form data (ST34). The print section 2c receives and saves the transmitted form data as a form (ST42).

The control section 2a stores the adID, present time (print time), and shop code set in the cash register 1 of the POS system in the application form ID DB 23 (the application form ID table 23A or application form ID table 23B), and issues an application form ID (ST35). In this case, where the POS account data (basket data) for the customer is not provided, the control section 2a uses the application ID table 23A shown in FIG. 8. Where it is provided, the control section 2a uses the application ID table 23B shown in FIG. 9.

Using the application form print data file structure 21c, the control section 2a acquires a bar code print position from the layout.ini file 21d in the folder (print application form folder) having a name indicated by the application form print data in the advertisement data table 21a (ST36). The control section 2a converts the application ID to a bar code and instructs the print section 2c to print the bar code at the bar code print position (ST37).

The print section 2c receives a print instruction from the control section 2a in step ST37 as print data (ST43), and combines the print data with the form saved in step ST42 to print out the application form (ST44).

If there is detailed information print data (ST38), the control section 2a sends the detailed information print data to the print section 2c and instructs printing thereof (ST39).

The print section 2c receives the detailed data (ST45) and prints the detailed print data (ST46).

The control section 2a checks whether there is a non-printed RelAdID (ST40). If there is no non-printed RelAdID, the control section 2a finishes the process.

If there is a non-printed RelAdID in step ST40, the control section 2a chooses a single non-printed RelAdID and instructs the print section 2c to print the application form of the associated advertisement, using the procedure of steps ST33 to ST37 (ST41). In accordance with the print instruction from the control section 2a in step ST41, the print section 2c performs printing in steps ST42 to ST44.

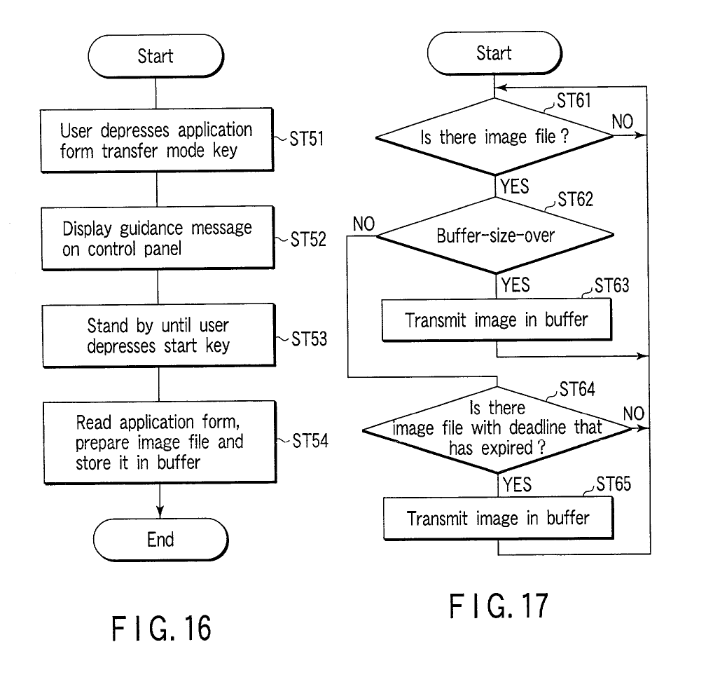

Referring to a flow chart of FIG. 16, an operation of transferring an image of the application form from the digital copying machine 2 to the data center 7 will now be described. Assume that the customer has already prepared the application form with necessary items filled in.

When the customer has depressed the application mode switch button 32 of the control panel 30 shown in FIG. 2 (ST51), the control section 2a of digital copying machine 2 switches the mode to the application mode. The control section 2a displays the guidance message, as shown in FIG. 14, on the display section 31 of the control panel 30 (ST52) and stands by until the user depresses the start key 35 (ST53).

When the start key 35 has been depressed, the control section 2a reads the application form, compresses the read data, produces an image file and stores the image file in the buffer 2d provided in the control section 2a (ST54). At this time, the control section 2a sets, as a transmission deadline, a time calculated by adding a predetermined time to the present time.

An operation for image file transmission in the digital copying machine 2 will now be described with reference to a flow chart of FIG. 17.

To start with, the control section 2a of digital copying machine 2 checks whether there is a non-transmitted image file in the buffer 2d (ST61). If there are non-transmitted image files in the buffer 2d and if the total capacity of the non-transmitted image files exceeds a predetermined value (buffer-size-over, ST62), the control section 2a transmits all image files in the buffer 2d to the data center 7 via the intra-shop network 3, intra-shop first router 4, shop network 5 and second router 6 (ST63).

If the total capacity of the non-transmitted image files does not exceed the predetermined value in step ST62, the control section 2a checks whether there is any one of the non-transmitted image files, the transmission deadline for which has expired (ST64). If there is an image file with the deadline that has expired, the control section 2a transmits all the image files in the buffer 2d (ST65). In this way, the control section 2a transmits the image files in the buffer 2d to the data center 7.

A second embodiment of the invention will now be described.

The second embodiment differs from the first embodiment in that an inventory management function is added, and a description of common parts is omitted.

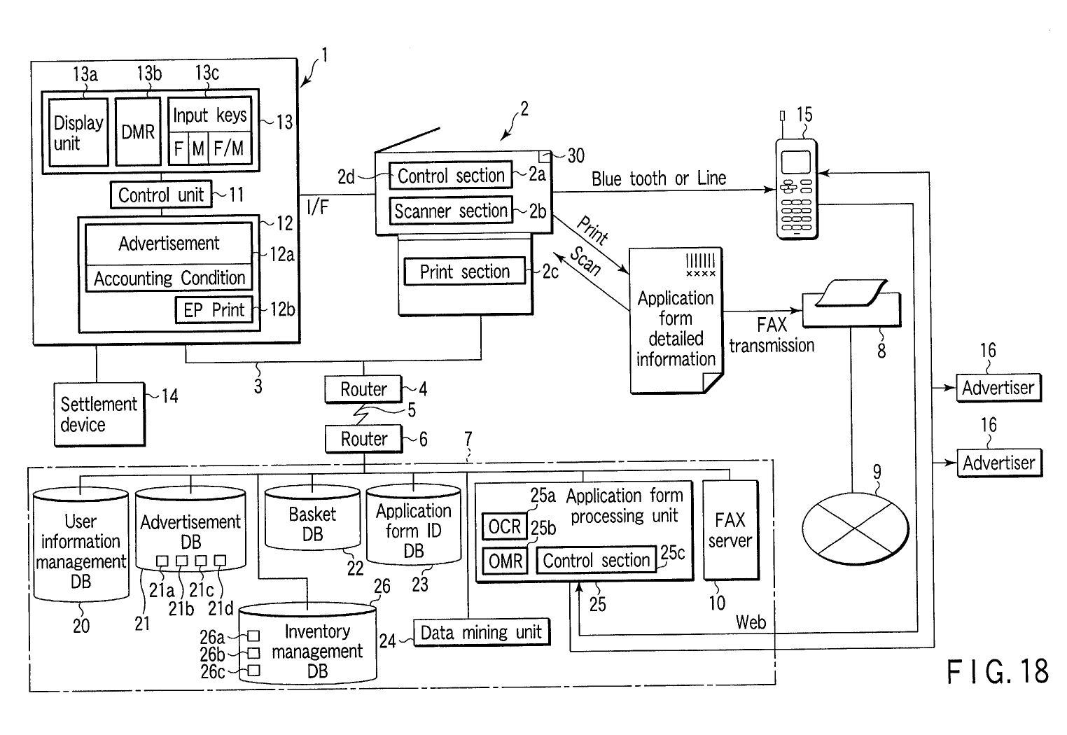

In FIG. 18, compared to FIG. 1, an inventory management database (DB) 26 for inventory management is added. The inventory management DB 26 comprises an inventory table 26a, a substitute commodity table 26b and a substitute commodity table 26c.

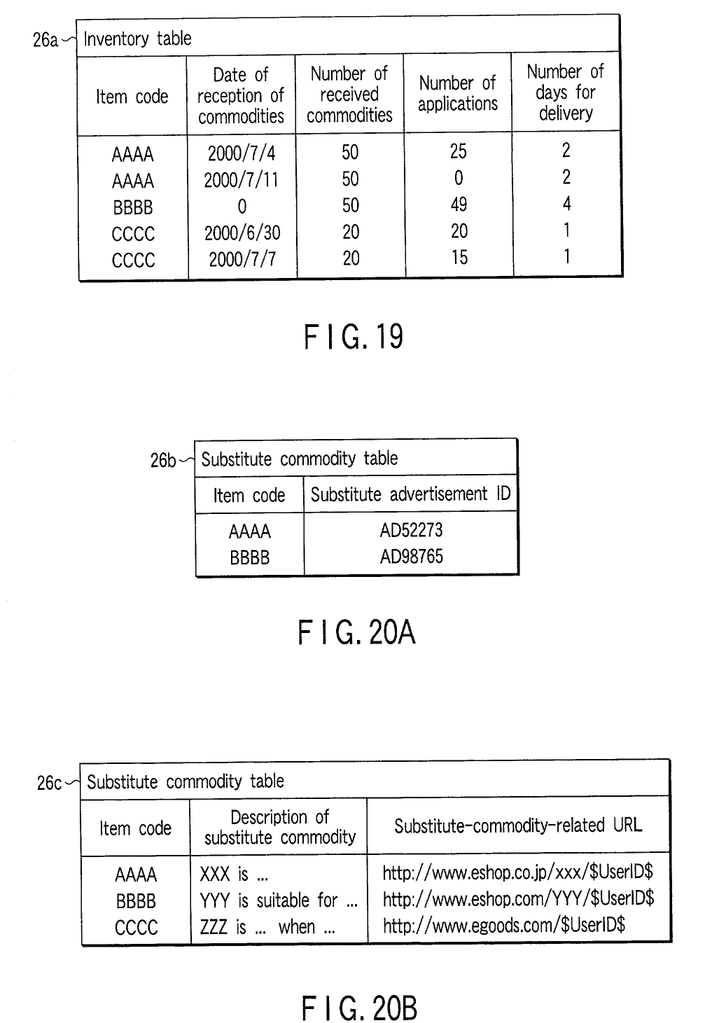

FIG. 19 shows the structure of the inventory table 26a relating to individual items to be applied for by an application form. This inventory table manages inventories. In association with an item code of each commodity, the inventory table stores inventory data comprising the date of reception of commodities, the number of received commodities, the number of applications and the number of days for delivery.

FIG. 20A shows the structure of the substitute commodity table 26b. The substitute commodity table 26b stores a substitute advertisement ID of a commodity, information of which is provided when a commodity that was applied for is out of stock, in association with an item code of each commodity. The substitute advertisement ID may be managed not for each item but for each advertisement.

FIG. 20B shows the structure of the substitute commodity table 26c. The substitute commodity table 26c stores a URL of an e-commerce site handling a commodity, information of which is provided when a commodity that was applied for is out of stock. Specifically, the substitute commodity table 26c stores a description of a substitute commodity and a substitute-commodity-related URL.

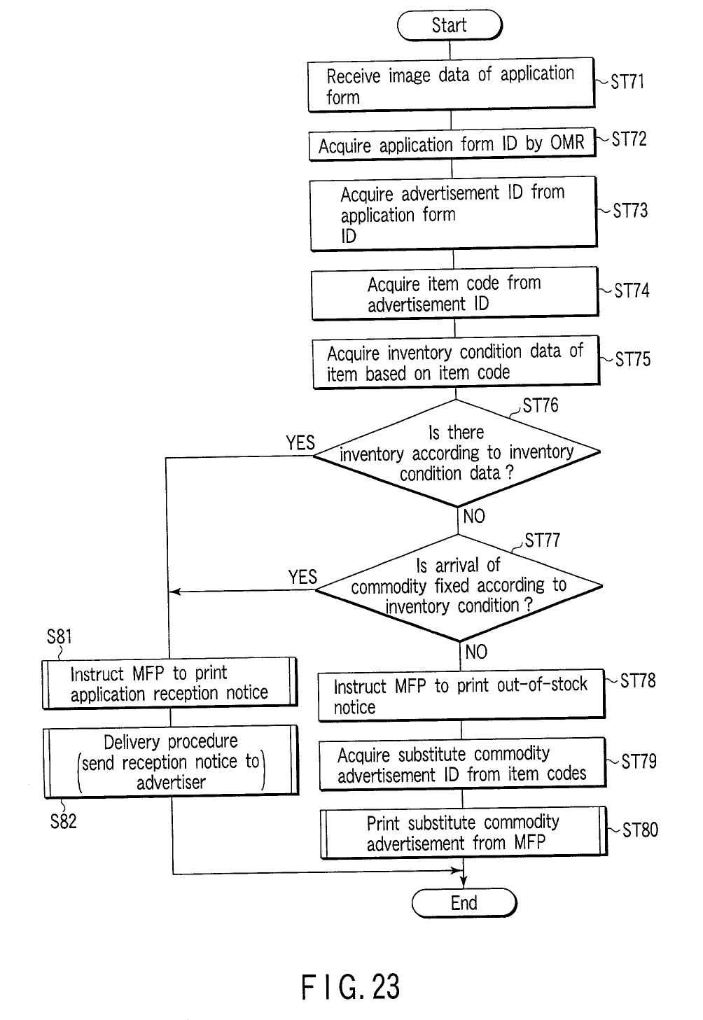

Referring to a flow chart of FIG. 23, a description will now be given of a processing operation of the application form processing unit 25 in the data center 7 in a case where if a commodity, which has been applied for, is out of stock, the user is informed to that effect and an application form for a substitute commodity is printed.

Upon receiving image data of the application form (ST71), the application form processing unit 25 uses the OMR 25b and extracts the application form ID from the bar code on the application form in the received image data (ST72).

Using the application form ID, the application form processing unit 25 searches the application form ID DB 23 to obtain the advertisement ID (ST73). Then, using the advertisement ID, the application form processing unit 25 searches the advertisement DB 21 to obtain the item code (ST74).

Using the item code, the application form processing unit 25 searches the inventory table 26a shown in FIG. 19 to obtain inventory condition data (search result: the date of reception of commodities, the number of received commodities, the number of applications and the number of days for delivery) (ST75).

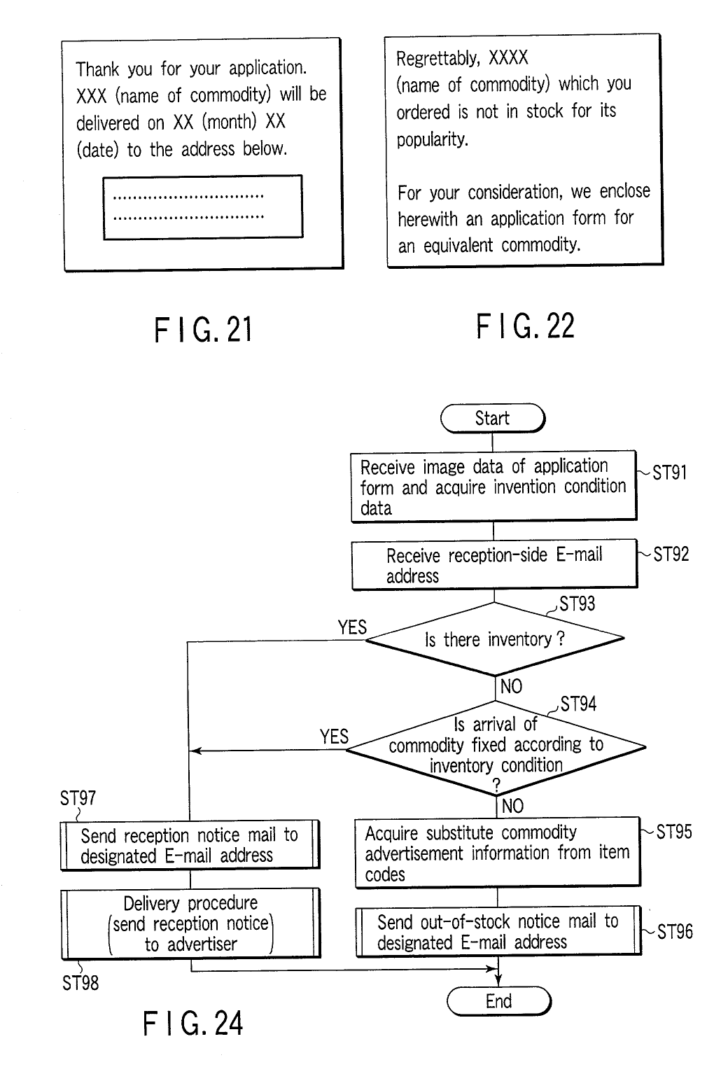

If the inventory condition data includes a record on an item with the date (date of reception of commodities) prior to the present day and with the number of applications less than the number of received commodities (ST76), the application form processing unit 25 transmits, to the digital copying machine 2 operated by the customer, application reception notice information to the effect that the item of the record can be delivered after the necessary number of days, and instructs the printing thereof (ST81). The control section 2a of the digital copying machine 2 prints out an application reception notice, as shown in FIG. 21, based on the received application reception notice information. FIG. 21 shows an example of the application reception notice, which reads: “Thank you for your application. XXX (name of commodity) will be delivered on XX (month) XX (date) to the address below.” Furthermore, the application form processing unit 25 transmits, in a delivery procedure, the image data of the application form to the advertiser 16 by E-mail (ST82) and finishes the process.

If there is no inventory in step ST75 (ST76) and if the inventory condition data includes a record on an item with the date in the future and with the number of applications less than the number of received commodities (ST77), the application form processing unit 25 transmits, to the digital copying machine 2 operated by the customer, application reception notice information to the effect that the item of the record will be delivered on the date calculated based on the date of reception and the necessary number of days for delivery, and instructs the printing thereof (ST81). The control section 2a of the digital copying machine 2 prints out an application reception notice, as shown in FIG. 21, based on the received application reception notice information. Furthermore, the application form processing unit 25 transmits, in a delivery procedure, the image data of the application form to the advertiser 16 by E-mail (ST82) and finishes the process.

If there is no inventory and the date of reception of commodities is not specified in steps ST76 and ST77, the application form processing unit 25 transmits out-of-stock notice information to the digital copying machine 2 operated by the customer, and instructs the printing thereof (ST78). Based on the received out-of-stock notice information, the control section 2a of digital copying machine 2 prints out an out-of-stock notice as shown in FIG. 22. FIG. 22 shows an example of the out-of-stock notice, which reads: “Regrettably, XXXX (name of commodity) which you ordered is not in stock for its popularity. For your consideration, we enclose herewith an application form for an equivalent commodity.”

Further, using the item code obtained in step ST74, the application form processing unit 25 searches the substitute commodity table 26b shown in FIG. 20A and acquires a substitute advertisement ID (adID) (ST79). The application form processing unit 25 sends the substitute advertisement ID (adID) to the digital copying machine 2 and instructs the printing of the advertisement of the substitute commodity. Based on the received substitute advertisement ID (adID), the control section 2a of digital copying machine 2 prints out the application form for the commodity of the substitute commodity advertisement as well as detailed information according to the operation of steps ST33 to ST47 in FIG. 15 (ST80).

Referring to a flow chart of FIG. 24, a description will now be given of an operation in a case where if a commodity, which has been applied for, is out of stock, the application form processing unit 25 notifies the user by E-mail and an application for a substitute commodity is made via the Web.

The application form processing unit 25 receives image data of the application form, acquires the application form ID, and obtains inventory condition data on the basis of the item code (ST91).

The application form processing unit 25 accesses the application form print data file structure 21b on the basis of the application ID, determines the area storing the E-mail address with reference to the layout.ini structure 21c, and acquires the reception-side E-mail address using the OCR 25a (ST92).

If the inventory condition data includes a record on an item with the date prior to the present day and with the number of applications less than the number of received commodities (ST93), the application form processing unit 25 transmits by E-mail, to the reception-side E-mail address, an application reception notice to the effect that the item of the record can be delivered after the necessary number of days (ST97), and transmits in a delivery procedure the image data of the application form to the advertiser 16 by E-mail (ST98) and finishes the process.

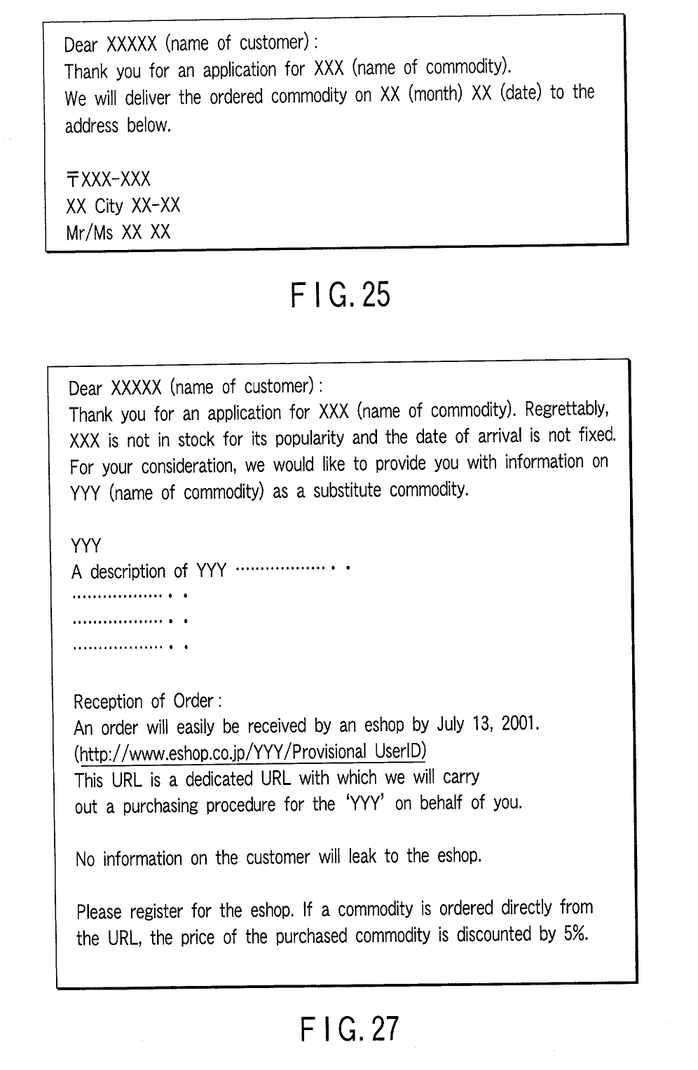

FIG. 25 shows an example of the mail of the application reception notice, which reads: “Dear XXXXX (name of customer): Thank you for an application for XXX (name of commodity). We will deliver the ordered commodity on XX (month) XX (date) to the address below. (Address and Name).”

If there is no inventory in step ST91 (ST93) and if the inventory condition data includes a record on an item with the date in the future and with the number of applications less than the number of received commodities (ST94), the application form processing unit 25 transmits by E-mail, to the reception-side E-mail address, an application reception notice, as shown in FIG. 25, to the effect that the item of the record will be delivered on the date calculated based on the date of reception and the necessary number of days for delivery (ST97), and transmits in a delivery procedure the image data of the application form to the advertiser 16 by E-mail (ST98) and finishes the process.

If there is no inventory and the date of reception of commodities is not specified in steps ST93 and ST94, the application form processing unit 25 prepares an out-of-stock notice including a description of a commodity, by referring to the substitute commodity table 26c shown in FIG. 20B, and mails it to the reception-side E-mail address (ST96).

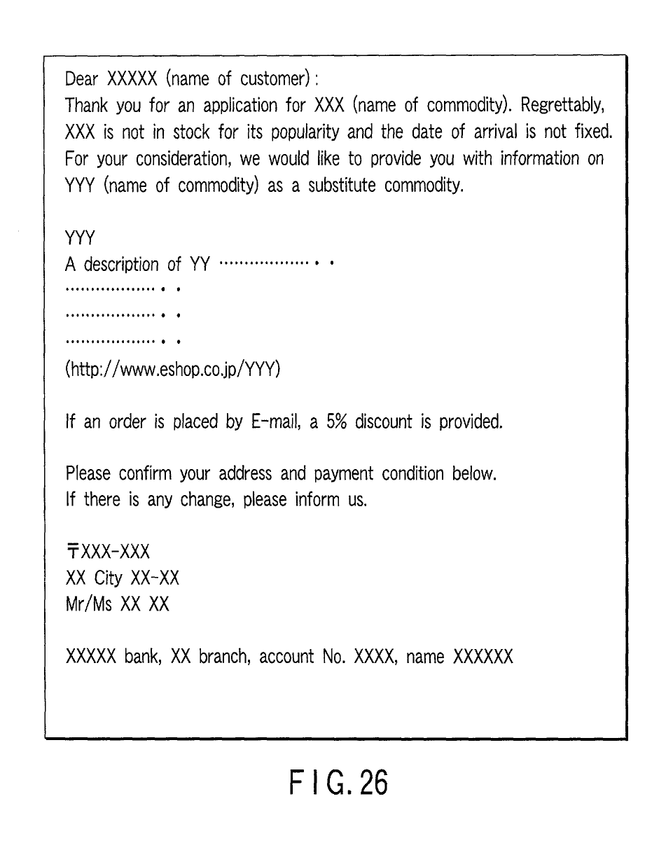

FIG. 26 shows an example of the mail of the out-of-stock notice, which reads: “Dear XXXXX (name of customer): Thank you for an application for XXX (name of commodity). Regrettably, XXX is not in stock for its popularity and the date of arrival is not fixed. For your consideration, we would like to provide you with information on YYY (name of commodity) as a substitute commodity.” Thus, the information on the commodity, the address, the condition of payment, etc. are stated.

Alternatively, when the application form is scanned by the digital copying machine, a user's profile may be acquired from the user's mobile phone/terminal, and the E-mail address of the user, as the reception-side address, may be sent to the application form processing unit 25. Publicly known technical means such as radio connection using Bluetooth may be used as means for acquiring the user's profile from the user's mobile phone/terminal. In this case, the E-mail address of the user's mobile telephone/terminal is acquired as a reception-side mail address.

Alternatively, instead of sending an E-mail to the user's reception-side E-mail address, a local short message may be sent to the user's mobile phone/terminal by Bluetooth via the digital copying machine 2 that has scanned the application form.

Alternatively, in step ST96, provisional user registration may be made at an e-mall, and a URL (Uniform Resource Locator) with which a procedure can be carried out with the user ID may be prepared. An out-of-stock notice mail including the URL may thus be produced.

For example, the URL may be formed as follows.

A contract with an e-mall is made in advance, and a method of producing a dedicated URL for a provisional user ID is predetermined. An example is http://www.eshop.co.jp/YYY/$UserID$ (←this portion will be replaced with a user ID). This is stored in the “substitute-commodity-related URL” of the substitute commodity table 26c shown in FIG. 20B. In this state, the e-mall is accessed and a provisional user ID is issued. The provisional user ID is applied to the URL taken out of the “substitute-commodity-related URL.” Thus, the dedicated URL for the provisional user ID is obtained.

FIG. 27 shows an example of the mail of the out-of-stock notice, which reads: “Dear XXXXX (name of customer): Thank you for an application for XXX (name of commodity). Regrettably, XXX is not in stock for its popularity and the date of arrival is not fixed. For your consideration, we would like to provide you with information on YYY (name of commodity) as a substitute commodity.” This statement is followed by: “Reception of Order: An order will easily be received by an eshop by Jul. 13, 2001. (http://www.eshop.co.jp/YYY/Provisional UserID) This URL is a dedicated URL with which we will carry out a purchasing procedure for the ‘YYY’ (name of commodity) on behalf of you. No information on the customer will leak to the eshop. Please register for the eshop. If a commodity is ordered directly from the URL, the price of the purchased commodity is discounted by 5%.”

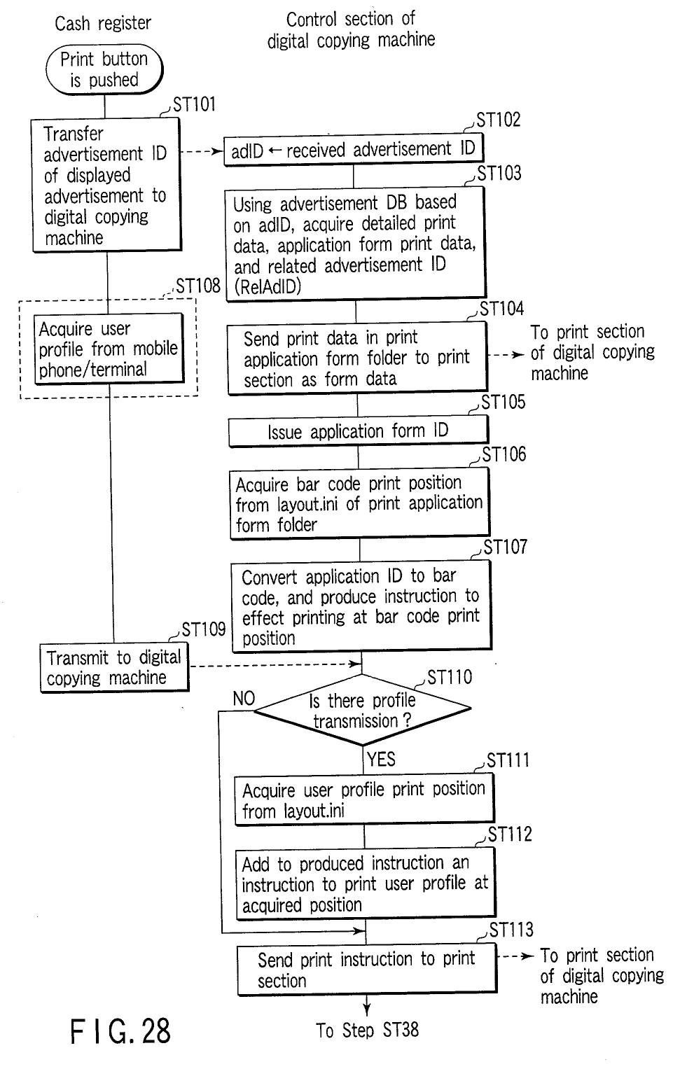

Another embodiment of the application form printing operation in steps ST31 to ST37 in FIG. 15 will now be described with reference to a flow chart of FIG. 28.

When the customer has depressed the print button 12b of the customer display device 12, the control unit 11 of the cash register 1 transfers the advertisement ID of the displayed advertisement to the digital copying machine 2 (ST101).

The control section 2a of the digital copying machine 2 sets the received advertisement ID to be adID (ST102). Using the advertisement DB 21 based on the adID, the control unit 2a acquires detailed print data, application form print data and a related advertisement ID (RelAdID) (ST103). Using the application form print data file structure 21b, the control unit 2a obtains print data (Print.pdf) from the folder (print application form folder) having a name indicated by the application print data in the advertisement DB 21, and transmits it to the print section 2c as form data (ST104).

The control section 2a stores the adID, present time (print time), and shop code set in the cash register 1 of the POS system in the application form ID DB 23, and issues an application form ID (ST105).

Using the application form print data file structure 21b, the control section 2a acquires a bar code print position from the layout.ini file 21c in the folder (print application form folder) having a name indicated by the application form print data in the advertisement DB 21 (ST106). The control section 2a converts the application ID to a bar code and produces a print instruction to print the bar code at the bar code print position acquired in step ST106 (ST107).

When the control unit 11 of the cash register 1 is accessible to a personal verification ID card or a mobile phone/terminal, it acquires a user profile (ST108) and transmits the acquired user profile to the digital copying machine 2 (ST109).

If the control section 2a of digital copying machine 2 has received the user profile from the cash register 1 (ST110), it acquires the information on the print position of the user profile from the layout.ini file 21c (ST11).

The control section 2a adds the information on the print position of the acquired user profile to the print instruction produced in step ST107 (ST112).

The control section 2a sends the print instruction to the print section 2c, instructs the printing thereof (ST113) and advances to step ST38.

If no profile is transmitted in step ST110, the control section 2a immediately goes to step ST113.

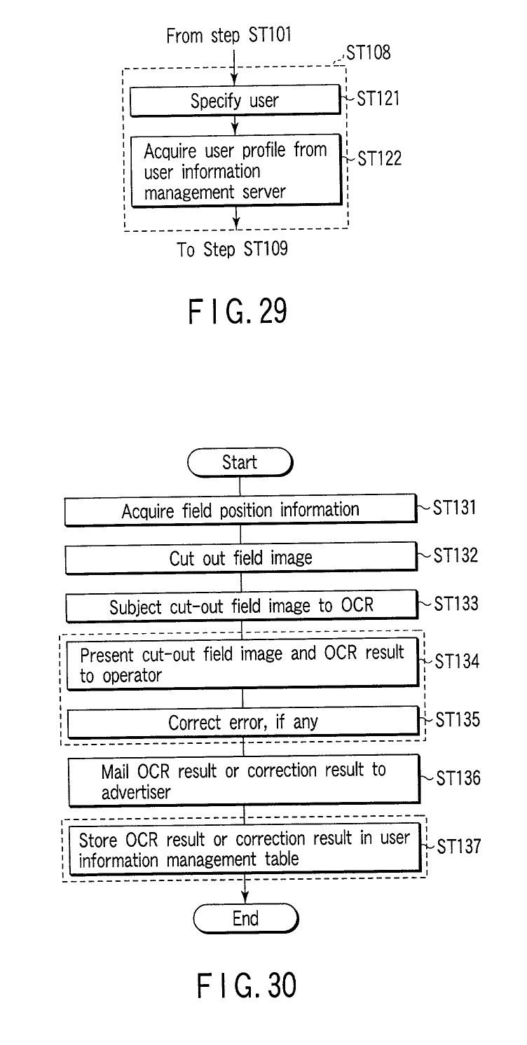

An embodiment of the operation of step ST108 will now be described with reference to a flow chart of FIG. 29. In step ST108, the control unit 11 of cash register 1 specifies the user (ST121), searches the user information management DB 20 of data center 7 via the intra-shop network 3, intra-shop first router 4, shop network 5 and second router 6, and acquires the user profile (ST122).

The application form processing operation of the application form processing unit 25 will now be described with reference to a flow chart of FIG. 30.

The application form processing unit 25 acquires position information of each field from the layout.ini (ST131). Using the position information of each field, the application form processing unit 25 cuts out a field image from the received application form image (ST132). The application form processing unit 25 takes out necessary data (reception-side address) from each cut-out field image using the OCR 25a (ST133).

In addition, the application form processing unit 25 presents to the operator by means of a display (not shown) the data including the data before and after the cutting-out of necessary data by the OCR 25a (ST134). If the operator finds an error in the presented data, he/she corrects it through an input section (not shown) (ST135).

Steps ST134 and ST135 may be omitted.

Based on the application form ID previously taken out by means of the OMR 25b, the application form processing unit 25 refers to the application-reception-side table 21a of the advertisement DB 21, acquires a reception E-mail address, and sends a mail to this address as the reception-side address of the advertiser 16 (ST136). In this case, the application form image and OCR result (or a correction thereof) are contained in the mail.

The application form processing unit 25 stores the result of the OCR 25a and the user profile confirmed by the operator in the user information management DB 20 (ST137). In other words, the user information management DB 20 accumulates information independently, without transfer of data from user information management databases of telephone companies and credit companies.

Step ST137 may be omitted.

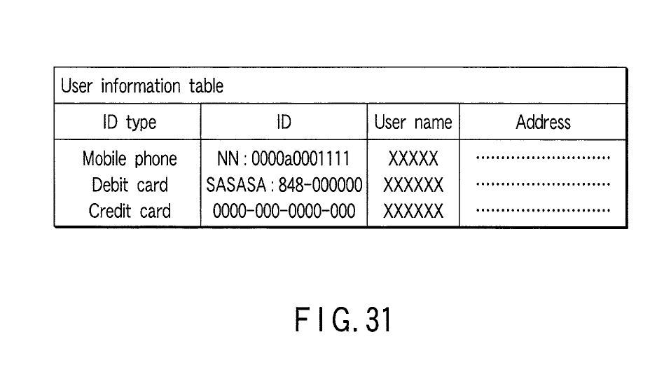

FIG. 31 shows an example of the user information management DB 20. A user information table stored in the user information management DB 20 comprises an ID type, an ID, a user name and an address.

The operation of the data mining unit 24 will now be described.

The data mining unit 24 performs data mining using the application form ID DB 23, basket DB 22 and advertisement DB 21. The data mining unit 24 reflects results of data mining on the advertisement time of the advertisement DB 21, TargetProfile, related commodity item codes, and related advertisement IDs. The data mining unit 24 may be operated at a timing, for example, each time an application form is printed, each time an application is made, at regular intervals, or when an advertisement order is placed (i.e. when a record is inserted in the advertisement DB 21). Of course, the result of data mining may be used as materials for advertisement business.

For example, when a related commodity item code is adjusted as additional information to be printed on an application form, the data mining unit 24 performs a correlation analysis, paying attention to the commodities contained in the basket data at the time the application form has been printed. Assume that it has been found that a commodity A is contained with a high probability at the time of printing the application form. In this case, if the commodity A is not included in the related commodity item codes of the advertisement of the application form, the data mining unit 24 adds the commodity A to the related commodity item codes of the advertisement.

As has been described above, according to the embodiments of the present invention, when a customer, who has an interest in an advertisement displayed on a customer display device of a cash register of a POS system, has depressed a print button, not only an application form but also detailed commodity information is provided. Thereby, an effective description of a commodity can be provided and, accordingly, a sales increase can be achieved, without increasing an occupation time of the POS system or decreasing the work efficiency of a store clerk at the cash register.

In addition, since an advertisement of a related commodity is displayed as detailed information, a great increase in sales can be expected.

An application form, which is not a postcard but a facsimile-adaptable form, is provided. Thus, the customer is prompted to fill in necessary items on the form as soon as he/she goes back to home, and to make an application using a household facsimile device before losing interest.

Furthermore, an application form containing an ID and various data is provided, it is possible to total information on when an advertisement was displayed on a cash register of the POS system and what conditions (time or time point of purchase of commodities) are associated with applications. Thereby, useful data for next advertisements can be collected.

What is claimed is:

1. A processing system comprising a terminal device for performing sales management of a commodity purchased by a customer, on the basis of a commodity code put on the commodity, a copying machine connected to the terminal device over a line, and a center, connected to the terminal device over a line, for managing the terminal device, wherein
the center comprises:
first transmission means for transmitting advertisement information to the terminal device; and
a database for storing print data of detailed information of the advertisement or an application form,
the terminal device comprises:
display means for displaying the advertisement to the customer on the basis of the advertisement information transmitted from the center;
instruction means, provided near the display means, for instructing printing of the detailed information of the advertisement or the application form, which is displayed on the display means; and
processing means for reading out the print data of the displayed detailed information of the advertisement or the application form from the database of the center in accordance with an instruction from the instruction means, and transmitting the read-out data to the copying machine, and
the copying machine comprises:
printing means for performing printing based on the print data of the detailed information of the advertisement or the application form, which is transmitted from the terminal device.

2. A processing system according to claim 1, wherein the database stores the detailed information of the commodity of the advertisement or print data of the application form, as well as detailed information of a related commodity and print data of an application form.

3. A processing system according to claim 1 or 2, wherein the processing means reads out of the database of the center the detailed information of the commodity of the displayed advertisement or print data of the application form as well as detailed information of a related commodity and print data of an application form, and transmits the read-out result to the copying machine.

4. A processing system according to claim 1, wherein additional information such as an advertisement ID, a print date/time and a code representing a shop is added to the print data of the detailed information or the application form, which is read out by the processing means.

5. A processing system according to claim 1 or 4, wherein ID information added to additional information stored in the database of the center is added to the print data of the detailed information or the application form, which is read out by the processing means.

6. A processing system according to claim 1, wherein an ID of customer information managed by the center is added to the print data of the detailed information or the application form, which is read out by the processing means.

7. A processing system comprising a terminal device for performing sales management of a commodity purchased by a customer, on the basis of a commodity code put on the commodity, a copying machine connected to the terminal device over a line, and a center, connected to the terminal device over a line, for managing the terminal device, wherein
the center comprises:
first transmission means for transmitting advertisement information to the terminal device; and
a database for storing print data of detailed information of the advertisement or an application form,
the terminal device comprises:
display means for displaying the advertisement to the customer on the basis of the advertisement information transmitted from the center;
instruction means, provided near the display means, for instructing printing of the detailed information of the advertisement or the application form, which is displayed on the display means; and
processing means for reading out print data of the displayed detailed information of the advertisement or the application form from the database of the center in accordance with an instruction from the instruction means, and transmitting the read-out data to the copying machine, and
the copying machine comprises:
printing means for performing printing based on the print data of the detailed information of the advertisement or the application form, which is transmitted from the terminal device;
reading means for reading the application form which has been printed by the printing means and on which necessary items have been filled in; and
second transmission means for transmitting image data of the application form read by the reading means to the center.

8. A processing system according to claim 7, wherein the second transmission means transmits the image data by adding thereto additional information such as a read date/time and a shop code.

9. A processing system according to claim 7, wherein the second transmission means comprises:
memory means for temporarily storing the image data of the application form read by the reading means; and
transmission control means for executing a control to transmit to the center the image data stored in the memory means when the amount of the image data has reached a predetermined value.

10. A processing system comprising a terminal device for performing sales management of a commodity purchased by a customer, on the basis of a commodity code put on the commodity, a copying machine connected to the terminal device over a line, and a center, connected to the terminal device over a line, for managing the terminal device, the center having a facsimile server for receiving transmission information from a facsimile apparatus, wherein
the center comprises:
first transmission means for transmitting advertisement information to the terminal device; and
a database for storing print data of detailed information of the advertisement or an application form,
the terminal device comprises:
display means for displaying the advertisement to the customer on the basis of the advertisement information transmitted from the center;
instruction means, provided near the display means, for instructing printing of the detailed information of the advertisement or the application form, which is displayed on the display means; and
control means for reading out the print data of the displayed detailed information of the advertisement or the application form from the database of the center in accordance with an instruction from the instruction means, and executing a print-out control through the copying machine on the basis of the print data of the detailed information or the application form, and
the facsimile apparatus comprises:
reading means for reading the application form which has been printed from the copying machine by the control of the control means and on which necessary items have been filled in; and
transmission means for transmitting image data of the application form read by the reading means to the center.

11. A processing system comprising a terminal device for performing sales management of a commodity purchased by a customer, on the basis of a commodity code put on the commodity, a copying machine connected to the terminal device over a line, and a center, connected to the terminal device over a line, for managing the terminal device and transmitting advertisement information to the terminal device, the center having a database for storing print data of detailed information of an advertisement or an application form, wherein
the terminal device comprises:
display means for displaying the advertisement to the customer on the basis of the advertisement information transmitted from the center;
instruction means, provided near the display means, for instructing printing of the detailed information of the advertisement or the application form, which is displayed on the display means; and
processing means for reading out the print data of the displayed detailed information of the advertisement or the application form from the database of the center in accordance with an instruction from the instruction means, and transmitting the read-out data to the copying machine,
the copying machine comprises:
printing means for performing printing based on the print data of the detailed information of the advertisement or the application form, which is transmitted from the terminal device;
reading means for reading the application form which has been printed by the printing means and on which necessary items have been filled in; and
transmission means for transmitting image data of the application form read by the reading means to the center, and
the center comprises:
control means for transmitting, to the copying machine application, result information on an application by the application form, which is based on the image data of the application form transmitted by the transmission means, and executing a control to print out the result information of the application through the copying machine.

12. A processing system according to claim 11, wherein the control means executes, when the result of the application indicates that the commodity is out of stock, a control to output through the copying machine an application result accompanied with print data of advertisement information of a substitute commodity and an application form.

13. A processing system comprising a terminal device for performing sales management of a commodity purchased by a customer, on the basis of a commodity code put on the commodity, a copying machine connected to the terminal device over a line, and a center, connected to the terminal device over a line, for managing the terminal device and transmitting advertisement information to the terminal device, the center having a database for storing print data of detailed information of an advertisement or an application form, wherein
the terminal device comprises:
display means for displaying the advertisement to the customer on the basis of the advertisement information transmitted from the center;
instruction means, provided near the display means, for instructing printing of the detailed information of the advertisement or the application form, which is displayed on the display means; and
processing means for reading out the print data of the displayed detailed information of the advertisement or the application form from the database of the center in accordance with an instruction from the instruction means, and transmitting the read-out data to the copying machine,
the copying machine comprises:
printing means for performing printing based on the print data of the detailed information of the advertisement or the application form, which is transmitted from the terminal device;
reading means for reading the application form which has been printed by the printing means and on which necessary items have been filled in; and
transmission means for transmitting image data of the application form read by the reading means to the center, and
the center comprises:
information transmission means for transmitting, to a predetermined information transmission destination, result information on an application by the application form, which is based on the image data of the application form transmitted by the transmission means.

14. A processing system according to claim 13, wherein the information transmission destination, to which the result information is transmitted, is a mobile phone.

15. A processing system according to claim 13, wherein the information transmission means uses an E-mail.

16. A processing system according to claim 13, wherein the information transmission means uses an e-mall.

17. A processing system according to claim 13, wherein the copying machine is provided with setting means for setting an application mode for applying for a commodity.

18. A processing system comprising a terminal device for performing sales management of a commodity purchased by a customer, on the basis of a commodity code put on the commodity, a copying machine connected to the terminal device over a line, and a center, connected to the terminal device over a line, for managing the terminal device and transmitting advertisement information to the terminal device, the center having a database for storing print data of detailed information of an advertisement or an application form, wherein
the terminal device comprises:
settlement means for performing an accounting for the commodity purchased by the customer;
display means for displaying the advertisement to the customer on the basis of the advertisement information transmitted from the center;
instruction means, provided near the display means, for instructing printing of the detailed information of the advertisement or the application form, which is displayed on the display means;
processing means for reading out the print data of the displayed detailed information of the advertisement or the application form from the database of the center in accordance with an instruction from the instruction means, and transmitting the read-out data to the copying machine; and
transmission means for transmitting, when personal information has been acquired in the accounting by the settlement means, the personal information to the digital copying machine, and
the copying machine comprises:
reception means for receiving the print data of the detailed information and the application form, which has been transmitted from the processing means, and the personal information transmitted by the transmission means; and
control means for printing out the print data of the detailed information and the application form, which has been received by the reception means, by adding thereto the personal information.

19. A processing system according to claim 18, wherein the personal information acquired in the accounting by the settlement means is a personal profile such as an address acquired from a mobile phone, a credit card, a debit card, a settlement IC card, etc.

20. A processing system comprising a terminal device for performing sales management of a commodity purchased by a customer, on the basis of a commodity code put on the commodity, a copying machine connected to the terminal device over a line, and a center, connected to the terminal device over a line, for managing the terminal device and transmitting advertisement information to the terminal device, the center having a database for storing print data of detailed information of an advertisement or an application form, wherein
the terminal device comprises:
display means for displaying the advertisement to the customer on the basis of the advertisement information transmitted from the center;
instruction means, provided near the display means, for instructing printing of the detailed information of the advertisement or the application form, which is displayed on the display means; and
processing means for reading out the print data of the displayed detailed information of the advertisement or the application form from the database of the center in accordance with an instruction from the instruction means, and transmitting the read-out data to the copying machine,
the copying machine comprises:
printing means for performing printing based on the print data of the detailed information of the advertisement or the application form, which is transmitted from the terminal device;
reading means for reading the application form which has been printed by the printing means and on which necessary items have been filled in; and
transmission means for transmitting image data of the application form read by the reading means to the center, and
the center comprises:
recognition means for recognizing the filled-in information on the application form on the basis of the image data of the application form transmitted by the transmission means; and
transfer means for transferring the information recognized by the recognition means along with the image data to an advertiser of the advertisement.

21. A processing system according to claim 20, wherein the transfer means is an E-mail.

22. A processing system comprising a terminal device for performing sales management of a commodity purchased by a customer, on the basis of a commodity code put on the commodity, a copying machine connected to the terminal device over a line, and a center, connected to the terminal device over a line, for managing the terminal device, the center having a database for storing information including advertisement information, print data of detailed information of an advertisement or an application form, and accounting information of the commodity purchased by the customer, wherein
the terminal device comprises:
settlement means for performing an accounting for the commodity purchased by the customer;
display means for displaying the advertisement to the customer on the basis of the advertisement information transmitted from the center;
instruction means, provided near the display means, for instructing printing of the detailed information of the advertisement or the application form, which is displayed on the display means; and
control means for executing, when the printing has been instructed by the instruction means, a control to read out from the center the print data of the detailed information of the commodity of the displayed advertisement and the application form, and
the center comprises:
correlation analysis means for performing a correlation analysis on the basis of a database for storing the print data of the detailed information and the application form, which is read out by the control of the control means, a database for storing the advertisement information transmitted to the terminal device, and a database for storing accounting information acquired in the accounting by the settlement means; and
updating means for updating the database storing the advertisement information on the basis of a result of the correlation analysis means.

23. A processing system according to claim 22, wherein the updating means performs updating at regular time intervals.

24. A processing system according to claim 22, wherein the updating means performs updating at regular intervals.
